(19) United States
(12) Patent Application Publication
(10) Pub. No.: US 2007/0159820 A1
(43) Pub. Date: Jul. 12, 2007

(54) Light emitting diode lighting assembly

(75) Inventors: W. Todd Crandell, Minnetonka, MN (US); Gregory A. Stelmasik, Brooklyn Park, MN (US)

Correspondence Address: IPLM GROUP, P.A., POST OFFICE BOX 18455, MINNEAPOLIS, MN, 55418, US

(73) Assignee: StyImark, Inc.

(21) Appl. No.: 11/328,301

(22) Filed: Jan. 9, 2006

(51) Int. Cl. F21V 21/00

(52) U.S. Cl. 362/249

(57) ABSTRACT

A light emitting diode lighting assembly includes a display unit and lighting assemblies. The display unit includes a left vertical support on a left side, a right vertical support on a right side, and a front portion. The first lighting assembly is operatively connected to the left vertical support proximate the front portion and includes a first plurality of light emitting diodes and a first reflector. The second lighting assembly is operatively connected to the right vertical support proximate the front portion and includes a second plurality of light emitting diodes and a second reflector. The first reflector directs light from the first plurality of light emitting diodes toward the right side and the front portion and the second reflector directs light from the second plurality of light emitting diodes toward the left side and the front portion to uniformly illuminate contents of the display unit proximate the front portion.

### FIELD OF THE INVENTION

The present invention relates to a light emitting diode lighting assembly.

### BACKGROUND OF THE INVENTION

Display units, such as shelving units, refrigeration units, and freezer units, are commonly used in retail applications to display merchandise. The display units may be arranged into banks of wall displays so that the consumers may walk through aisles between the display units and readily view the merchandise contained in the display units. The display units may include vertical supports and doors, which in refrigeration units and freezer units allow consumers to see the merchandise contained in the display units without opening the display units and allow consumers access to the merchandise by simply opening one of the doors.

To enhance the visibility of the merchandise displayed in the display units, lighting may be incorporated into the display units. One way lighting has been incorporated into display units is by placing fluorescent lamps or other light sources horizontally within the display units, such as along horizontal supports, to provide lighting along the horizontal supports. Another way lighting has been incorporated into display units is by placing fluorescent lamps or other light sources vertically within the display units, such as along vertical supports. These approaches do not provide even lighting across the merchandise proximate the front of the display units, and to provide sufficient lighting within the display units, these approaches require the consumption of significant energy. For example, a standard fluorescent lamp 60 inches in length consumes as much as 60 to 70 watts and, to provide a comparable amount of lighting, light sources including a plurality of light emitting diodes consume a similar amount of energy because light emitting diodes have similar or lower efficacies (40 to 50 lumens per watt).

To date, light sources including a plurality of light emitting diodes provide little to no energy savings because a large number of light emitting diodes are required to provide a comparable amount of lighting. Further, the problems of non-uniform lighting, secondary spotting or “glare” effects, and unreasonable costs of manufacturing such light sources have not been solved by these light sources.

Therefore, it is desired to achieve uniform lighting of merchandise across the length of the display units with a light source that consumes considerably less energy and is economical to manufacture.

### SUMMARY OF THE INVENTION

In one aspect of the invention, a light emitting diode lighting assembly includes a display unit, a first lighting assembly, and a second lighting assembly. The display unit includes a front and at least one horizontal support. The front has a left vertical support on a left side of the display unit and a right vertical support on a right side of the display unit. The at least one horizontal support has a front portion proximate the left vertical support and the right vertical support. The first lighting assembly is operatively connected to the left vertical support proximate the front portion of the at least one horizontal support. The first lighting assembly includes a first plurality of light emitting diodes and a first reflector. The first plurality of light emitting diodes forms a first single row of light emitting diodes extending vertically in a first linear arrangement, each of the first plurality of light emitting diodes being spaced approximately 1.5 to 2.0 per linear foot from adjacent light emitting diodes. The first reflector directs light from the first plurality of light emitting diodes toward the right side of the display unit and the front portion of the at least one horizontal support and illuminates contents of the display unit proximate the front of the display unit. The second lighting assembly is operatively connected to the right vertical support proximate the front portion of the at least one horizontal support. The second lighting assembly includes a second plurality of light emitting diodes and a second reflector. The second plurality of light emitting diodes forms a second single row of light emitting diodes extending vertically in a second linear arrangement, each of the second plurality of light emitting diodes being spaced approximately 1.5 to 2.0 per linear foot from adjacent light emitting diodes. The second reflector directs light from the second plurality of light emitting diodes toward the left side of the display unit and the front portion of the at least one horizontal support and illuminates contents of the display unit proximate the front of the display unit.

In another aspect of the invention, a light emitting diode lighting assembly includes a plurality of light emitting diodes and a reflector. The reflector comprises a plurality of reflector portions. Each reflector portion corresponds with a light emitting diode and has a top partition, a bottom partition, and a front partition. The top partition and the bottom partition being concave walls with a radiused profile having a radius of approximately 2.38 to 2.88 inches with an arc length of approximately 2.10 to 2.35 inches. The front partition interconnects the top partition and the bottom partition above the light emitting diode. The top partition, the bottom partition, and the front partition direct light from the light emitting diode toward an opposing side of the light emitting diode.

In another aspect of the invention, a light emitting diode lighting assembly includes a plurality of light emitting diodes and a reflector. The reflector comprises a plurality of reflector portions. Each reflector portion corresponds with a light emitting diode and has a top left partition, a top right partition, a bottom left partition, a bottom right partition, and a front partition. The top left partition extends upward from proximate above the light emitting diode toward an upper left portion at an angle of approximately 43 to 47° from a first line extending perpendicular to a longitudinal axis of the reflector proximate above the light emitting diode. The top right partition extends upward from proximate above the light emitting diode toward an upper right portion at an angle of approximately 43 to 47° from the first line extending perpendicular to the longitudinal axis of the reflector proximate above the light emitting diode. The bottom left partition extends downward from proximate below the light emitting diode toward a lower left portion at an angle of approximately 43 to 47° from a second line extending perpendicular to the longitudinal axis of the reflector proximate below the light emitting diode. The bottom right partition extends downward from proximate below the light emitting diode toward a lower right portion at an angle of approximately 43 to 47° from the second line extending perpendicular to the longitudinal axis of the reflector proximate below the light emitting diode. The front partition interconnects the top left partition, the top right partition, the bottom left partition, and the bottom right partition proximate the light emitting diode. Each reflector portion directs light from the light emitting diode toward a left side and a right side of the reflector.

### BRIEF DESCRIPTION OF THE DRAWINGS

FIG. 1 is a front perspective view of a display unit including a light emitting diode lighting assembly constructed according to the principles of the present invention;

FIG. 2 is a rear perspective view of a door frame assembly of the display unit shown in FIG. 1 to which the light emitting diode lighting assembly is operatively connected;

FIG. 3 is a front view of a lighting assembly constructed according to the principles of the present invention that may be operatively connected to the door frame assembly shown in FIG. 2;

FIG. 3A is a front view of a top portion of the lighting assembly shown in FIG. 3;

FIG. 3B is a front view of a reflector of the lighting assembly shown in FIG. 3;

FIG. 3C is a cross section taken along the lines 3C-3C in FIG. 3B;

FIG. 4 is a front view of another embodiment lighting assembly constructed according to the principles of the present invention that may be operatively connected to the door frame assembly shown in FIG. 2;

FIG. 4A is a front view of a top portion of the lighting assembly shown in FIG. 4;

FIG. 4B is a side perspective view of a portion of the lighting assembly shown in FIG. 4;

FIG. 4C is a side view of a portion of the lighting assembly shown in FIG. 4;

FIG. 5 is a front view of another embodiment lighting assembly constructed according to the principles of the present invention that may be operatively connected to the door frame assembly shown in FIG. 2;

FIG. 5A is a front view of a top portion of the lighting assembly shown in FIG. 5;

FIG. 5B is a front view of a bottom portion of the lighting assembly shown in FIG. 5;

FIG. 5C is a top view of the lighting assembly shown in FIG. 5;

FIG. 5D is a cross section taken along lines 5D-5D in FIG. 5C;

FIG. 6 is an exploded side perspective view of the lighting assembly shown in FIG. 3;

FIG. 6A is an exploded side perspective view of a top portion of the lighting assembly shown in FIG. 3;

FIG. 6B is an exploded side perspective view of a bottom portion of the lighting assembly shown in FIG. 3;

FIG. 7 is an exploded side perspective view of the lighting assembly shown in FIG. 5;

FIG. 7A is an exploded side perspective view of a top portion of the lighting assembly shown in FIG. 5;

FIG. 7B is an exploded side perspective view of a bottom portion of the lighting assembly shown in FIG. 5; and

FIG. 8 is a graph showing illuminance values for fluorescent lighting, LED lighting, and LED lighting using the present invention.

### DETAILED DESCRIPTION OF A PREFERRED EMBODIMENT

The present invention relates to a light emitting diode lighting assembly that may be used with a variety of display units such as shelving units, refrigeration units, and freezer units. With reference to FIG. 1, an exemplary refrigeration unit 100 is shown. The refrigeration unit 100 is preferably enclosed on all sides to define a cavity 113 and includes doors 108 and 109 proximate the front 101 of the refrigeration unit 100 which may be opened for access to merchandise displayed within the cavity 113 on horizontal supports such as shelves 110. The doors 108 and 109 preferably include frames 108a and 109a with glass 108b and 109b, respectively, or any suitable translucent material so that the merchandise on the shelves 110 may be viewed through the doors 108 and 109. The front 101 of the refrigeration unit 100 includes a left vertical support 103 proximate the left side 102, a right vertical support 105 proximate the right side 104, and a middle vertical support 107 proximate the middle 106. The frame 108a is operatively connected to the left vertical support 103 and the middle vertical support 107 and the frame 109a is operatively connected to the right vertical support 105 and the middle vertical support 107 with the supports 103, 105, and 107 being inside of the refrigeration unit 100 as shown in FIG. 2. The shelves 110 include a front portion 111 proximate the front 101 and a rear portion 112 proximate the rear 114 of the refrigeration unit 100. When consumers are viewing merchandise in such display units, providing sufficient, even lighting across the front of the merchandise is a challenge. The present invention meets this challenge.

Although the lighting assemblies are preferably oriented vertically, the light assemblies may also be oriented horizontally to achieve a similar effect.

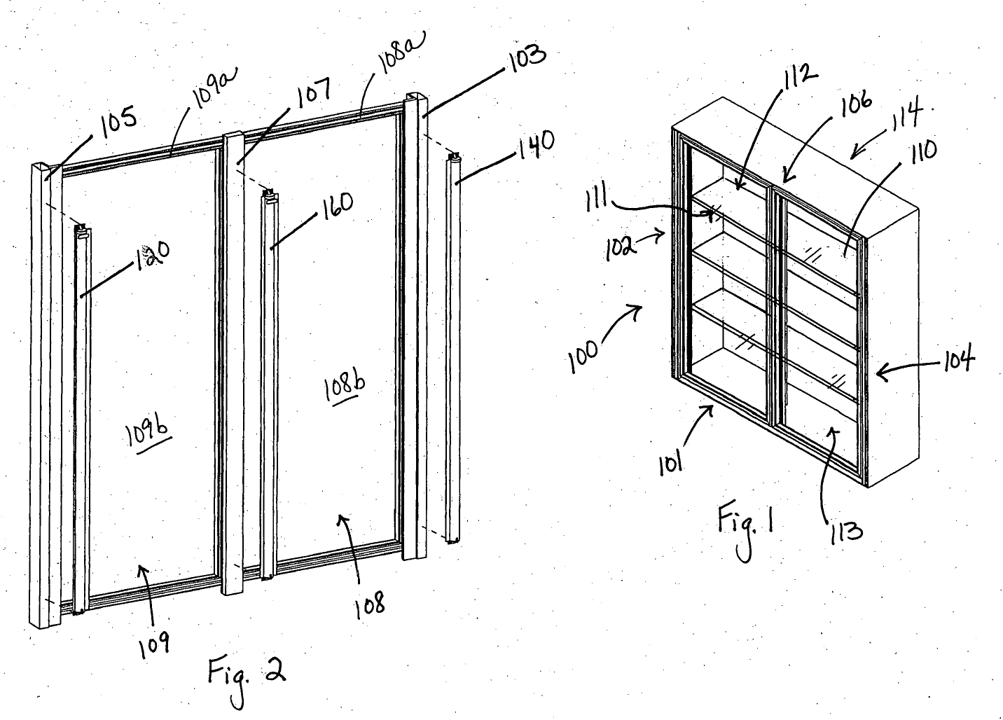

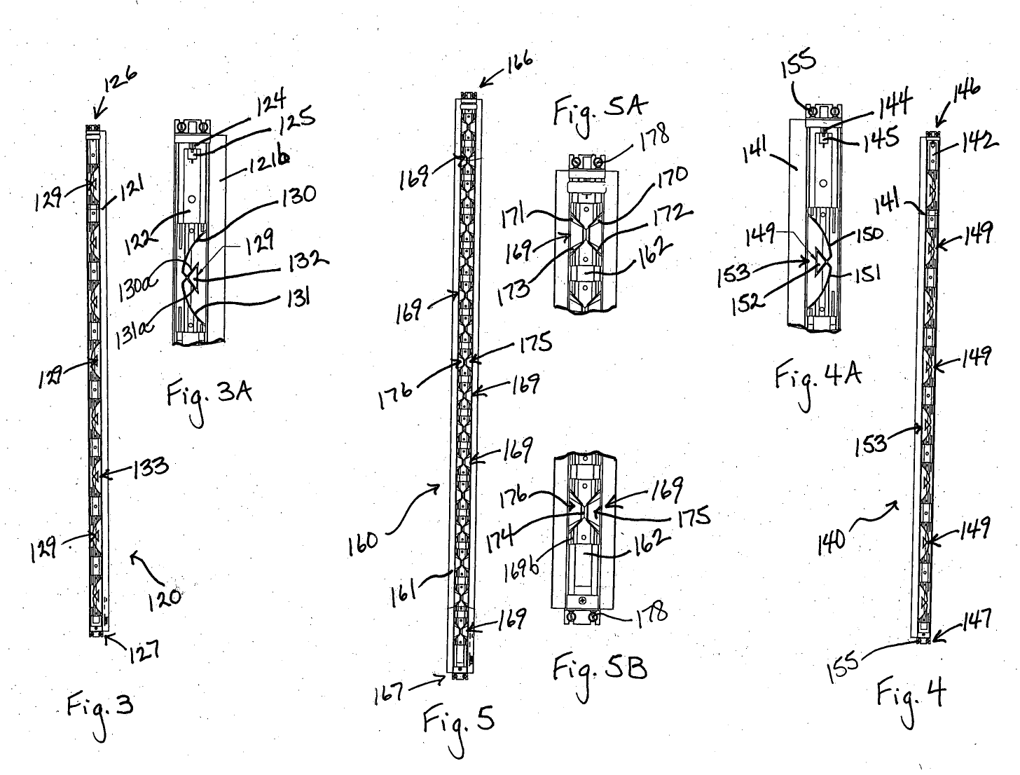

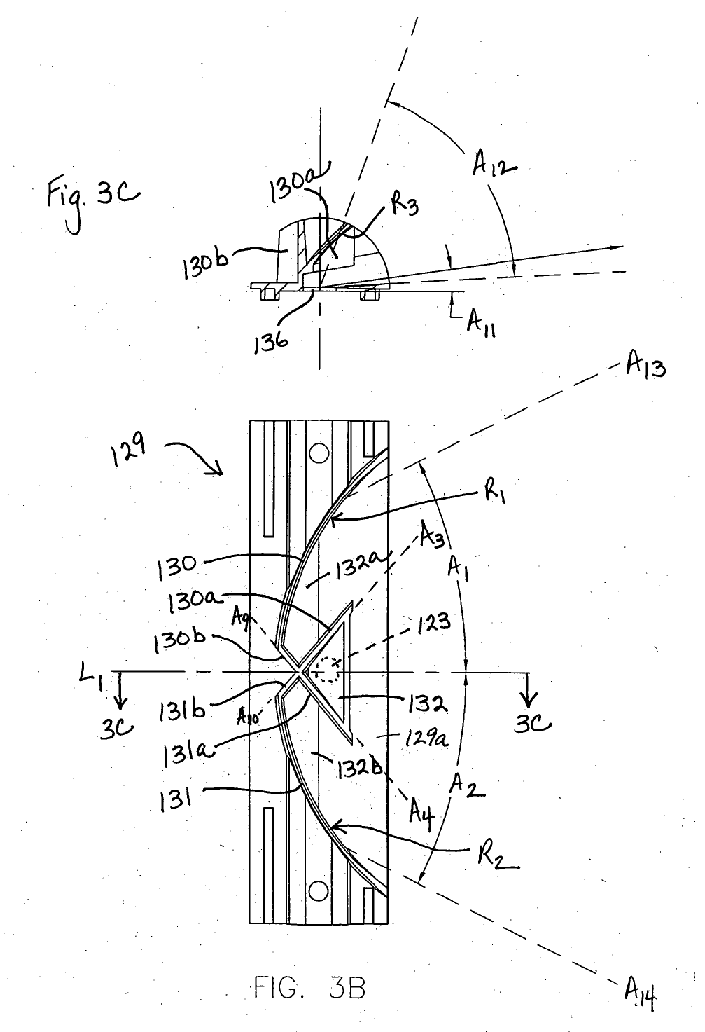

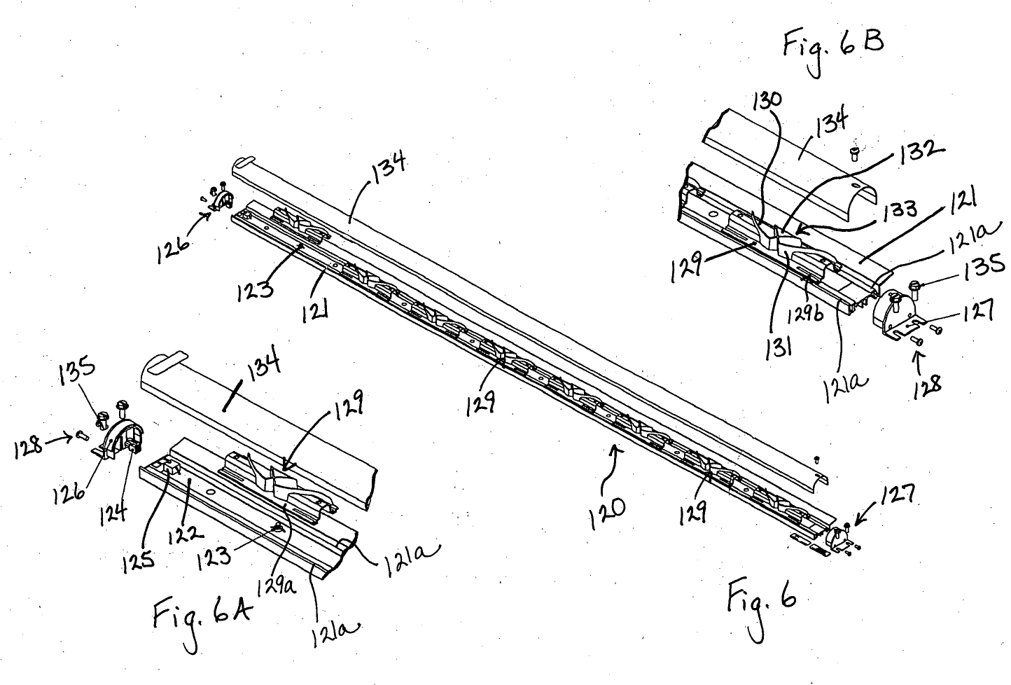

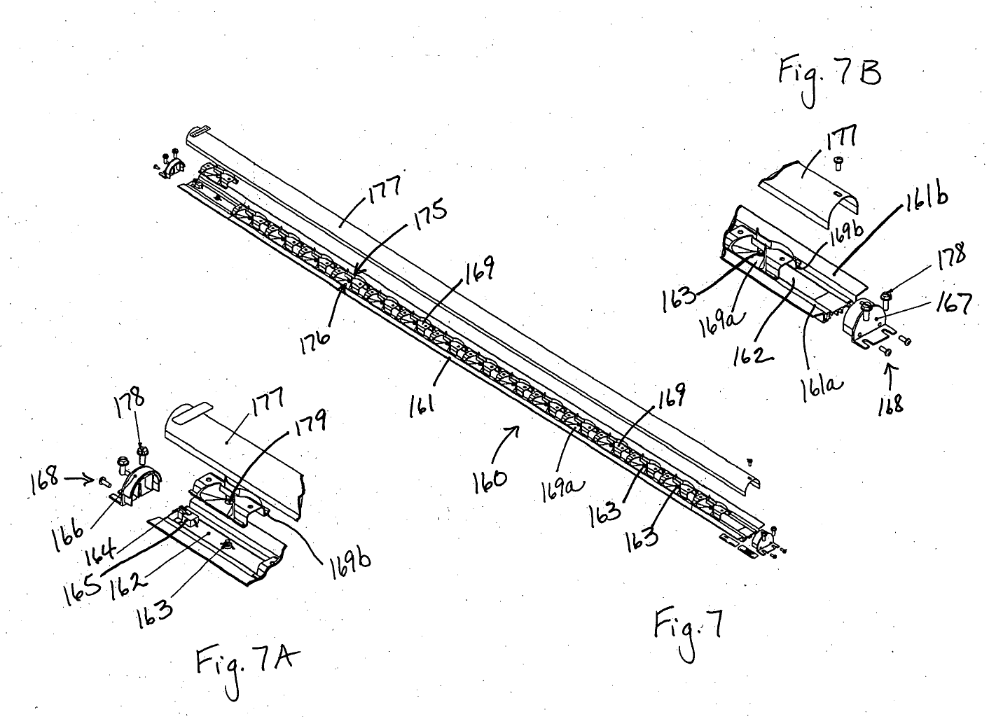

Operatively connected to the interior surface of the right vertical support 105 within the cavity 113 of the refrigeration unit 100 is a right lighting assembly 120, which is shown in FIGS. 3 and 6. Because the right lighting assembly 120 is shown and described as being in a vertical orientation, the other orientations are described relative to the right lighting assembly 120 in the vertical orientation. Should the right lighting assembly 120 be placed in a different orientation, it is understood that the other orientations would be adjusted accordingly. Further, the right lighting assembly 120 is also described in an orientation referred to as a front view although the front view of the right lighting assembly 120 is a different orientation than that described for the refrigeration unit 100 as shown in FIGS. 1 and 2.

The right lighting assembly 120 includes a heat sink 121, which is preferably an elongate piece of aluminum, onto which a flexible printed circuit board 122, a plurality of light emitting diodes (hereinafter “LEDs”) 123, and a plurality of reflectors 129 are operatively connected. The heat sink 121 provides a frame for the right lighting assembly 120 and also provides a mounting surface for mounting the right lighting assembly 120 to the right vertical support 105 of the refrigeration unit 100. The heat sink 121 includes a light reflecting flange 121b extending along its right side to assist in reflecting light to the right of the right lighting assembly 120 (to the left relative to the right vertical support 105 of the refrigeration unit 100). The flange 121b may be relatively flat or slightly curved or angled. The circuit board 122 is a thin, flexible circuit, which allows the LEDs 123 to be operatively connected directly to the heat sink 121 thus minimizing thermal resistance.

A connector receptacle 125 is operatively connected to the circuit board 122 by solder methods known in the art. This is shown in FIGS. 3A and 6A. The connector 124 is inserted into the connector receptacle 125 to interconnect a power supply (not shown) and the circuit board 122, which powers the LEDs 123.

The power supply and the circuit board are provided to supply appropriate drive current requirements known in the art. The heat sink 121 is matched with the drive current and the LEDs 123 to maintain operational junction temperature requirements of the LEDs 123. Preferably, the LEDs 123 are spaced approximately 1.5 to 2.0 per linear foot along the length of the heat sink 121. An example of a suitable LED that may be used is LUXEON Emitter, Part Number LXHL-DWO1, manufactured by Lumileds Lighting, LLC of San Jose, Calif. Preferably, only a single row of LEDs 123 is used. The LEDs 123 may alternate between white, which is approximately 600° to 630° Kelvin correlated color temperature (hereinafter “K CCT”), and warmer white, which is approximately 500° to 550° K CCT. The use of alternating white LEDs and warmer white LEDs results in a blended color temperature of approximately 530° to 570° K CCT for the right lighting assembly 120. The LEDs 123 may vary in minimum strength from 39.8 lumens to 50 lumens with a preferred minimum total luminous flux of approximately 450 lumens.

The top cap 126 is secured to the top end of the heat sink 121 with fasteners 128, and the top cap 126 may be secured to the right vertical support 105 with fasteners 135 as shown in FIG. 6A. A bottom cap 127 is secured to the bottom end of the heat sink 121 with fasteners 128, and the bottom cap 127 may be secured to the right vertical support 105 with fasteners 135 as shown in FIG. 6B.

The heat sink 121 includes grooves 121a extending longitudinally proximate each side of the heat sink 121. A reflector 129 corresponds with each of the LEDs 123. The reflectors 129 include a rectangular plate-like base 129a with protruberances 129b extending outward proximate each corner. The protruberances 129b friction-fit into the grooves 121a to operatively connect the reflectors 129 to the heat sink 121 proximate each of the LEDs 123 to direct the light emitted from each of the LEDs 123 in a desired direction. It is recognized that the reflectors 129 may be operatively connected to the heat sink 121 by other suitable means such as with fasteners or an adhesive.

The reflectors 129 also include an aperture 136 in the base 129a through which the corresponding LED 123 extends and partitions operatively connected to the base 129a to direct the light emitted from the LED 123. A center line L₁ of the LED 123 perpendicular to the longitudinal axis of the reflector 129 is shown in FIG. 3B. Approximately 0.15 to 0.35 inch to the left side of the LED 123 along center line L₁, an inner top partition 130a extends upward at an angle A₃ of approximately 48 to 52° from proximate the left side toward the right side of the LED 123 and an inner bottom partition 131a extends downward at an angle A₄ of approximately 48 to 52° from proximate the left side toward the right side of the LED 123. From the juncture of the inner top partition 130a and the inner bottom partition 131a, an outer top partition 130b extends upward at an angle A₃ of approximately 48 to 52° from the center line L₁ and an outer bottom partition 131b extends downward at an angle A₁₀ of approximately 48 to 52° from the center line L₁.

A top partition 130 extends upward from proximate the outer top partition 130b toward the right side of the LED 123 and a bottom partition 131 extends downward from proximate the outer bottom partition 131b toward the right side of the LED 123. Preferably, the top partition 130 and the bottom partition 131 are concave walls with a radiused profile having a radius R₁ and R₂, respectively, of approximately 2.38 to 2.88 inches with an arc length of approximately 2.10 to 2.35 inches. The radii R₁ and R₂ may be either constant or non-constant within the preferred radius range. The top partition 130, the outer top partition 130b, and the inner bottom partition 131 a may be contiguous; and the inner top partition 130a, the outer bottom partition 131b, and the bottom partition 131 may be contiguous. Preferably, the inner top partition 130a and the outer bottom partition 131b are in a line and the inner bottom partition 131a and the outer top partition 130b are in a line with the junctures of these partitions overlapping proximate the center line L₁ and the left side of the LED 123.

The partitions 130, 130a, 130b, 131, 131a, and 131b are walls extending generally perpendicularly relative to the base 129a forming an opening 133 through which the light is emitted. Preferably, the partitions 130, 130b, 131, and 131b are operatively connected to the base 129a and the partitions 130a and 131a are suspended approximately 0.6 to 0.7-inch above the base 129a, which allows some of the light emitted from the LED 123 to be reflected by the partitions 130, 130b, 131, and 131b. The top partition 130 and the bottom partition 131 are approximately 0.7 to 1.0 inch in height, the inner top partition 130a and the inner bottom partition 131a are approximately 0.9 to 1.1 inch in length and approximately 0.4 to 0.5 inch in height, and the outer top partition 130b and the outer bottom partition 131b are approximately 0.30 to 0.35 inch in length and approximately 0.60 to 0.63 inch in height. The inner partitions 130a and 131a are shorter in length than the top partition 130 and the bottom partition 131.

A front partition 132 interconnects the partitions 130a and 131a just above the top of the LED 123. Preferably, the front partition 132 is angled upward proximate the juncture of the partitions 130a and 131a toward the right side at an angle of approximately 42 to 48° and has a radius R₃ of approximately 1.42 to 1.62 proximate each partition 130a and 131a. A top front partition 132a is parallel to the base 129a and interconnects the partitions 130, 130a, and 130b approximately 0.6 to 0.7 inch above the base 129a. A bottom front partition 132b is parallel to the base 129a and interconnects the partitions 131, 131a, and 131b approximately 0.6 to 0.7 inch above the base 129a. The partitions 132a and 132b are preferably connected to the respective partitions proximate a middle portion of partitions 130, 130b, 131, and 131b, which provide support for the partitions 132a and 132b, and the partitions 130, 130b, 131, and 131b are preferably integral even though the portions above the partitions 132a and 132b do not reflect light. The partitions 132, 132a, and 132b block light above the top of the LED 123, and the base 129a blocks light below the LED 123. The partitions 130, 130a, 130b, 131, 131a, 131b, 132, 132a, and 132b along with the base 129a and the flange 121b direct the light to the right (left relative to the refrigeration unit 100) at angles A₁₃ and A₁₄ of approximately 32 to 40° perpendicular to the longitudinal axis of the reflector 129 and to angles A₁ and A₂ of approximately 24 to 30° above and below the perpendicular line as shown in FIG. 3B. Additionally, partitions 130, 130a, 130b, 131, 131a, 131b, 132, 132a, and 132b along with the base 129a and the flange 121b direct the light from each LED 123 to the inside of the display case 100 (away from the right vertical support 105) at a directed angle A₁₁ of approximately 4 to 12° (where a majority of the light is directed) and an angle A₁₂ through 0 to 57° (where the light has spread outward) as shown in FIG. 3C. Approximately 35% of the light from the LED 123 is directed between angles A₃ and A₄, and approximately 65% of the light from the LED 123 is directed between angles A₁ and A₂. The reflectors 129 are preferably made of a metal coated plastic, but any suitable reflective material may be used.

A cover 134, preferably made of a plastic such as polycarbonate, may be used to provide protection to the lighting assemblies without affecting the light uniformity and the illuminance values, preferably losing less than 15% transmissibility through the cover.

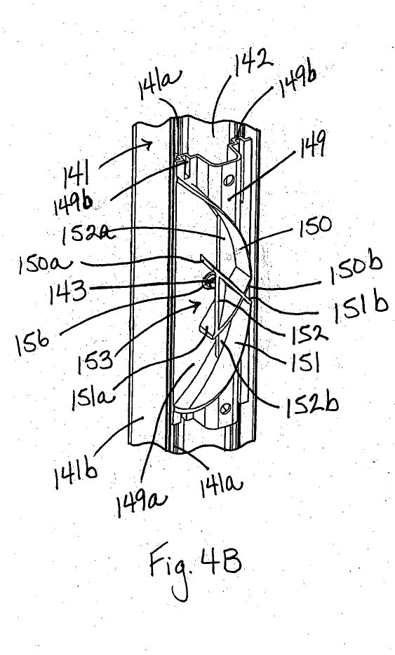

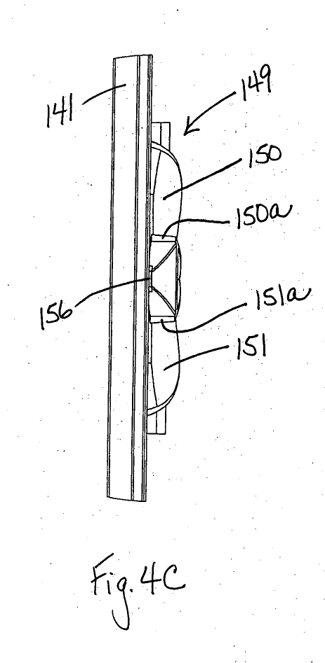

Operatively connected to the interior surface of the right vertical support 105 within the cavity 113 of the refrigeration unit 100 is a left lighting assembly 140, which is shown in FIG. 4. The left lighting assembly 140 is similar to the right lighting assembly 120 with the reflectors 149 being turned 180° to direct light emitted from the plurality of LEDs 143 to the right rather than to the left relative to the refrigeration unit 100. Because the left lighting assembly 140 is shown and described as being in a vertical orientation, the other orientations are described relative to the left lighting assembly 140 in the vertical orientation. Should the left lighting assembly 140 be placed in a different orientation, it is understood that the other orientations would be adjusted accordingly. Further, the left lighting assembly 140 is also described in an orientation referred to as a front view although the front view of the left lighting assembly 140 is a different orientation than that described for the refrigeration unit 100 as shown in FIGS. 1 and 2.

The left lighting assembly 140 includes a heat sink 141, which is preferably an elongate piece of aluminum, onto which a flexible printed circuit board 142, a plurality of light emitting diodes (hereinafter “LEDs”) 143, and a plurality of reflectors 149 are operatively connected. The heat sink 141 provides a frame for the left lighting assembly 140 and also provides a mounting surface for mounting the left lighting assembly 140 to the left vertical support 103 of the refrigeration unit 100. The heat sink 141 includes a light reflecting flange 141b extending along its left side to assist in reflecting light to the left of the left lighting assembly 140 (to the right relative to the left vertical support 103 of the refrigeration unit 100). The flange 141b may be relatively flat or slightly curved or angled. The circuit board 142 is a thin, flexible circuit, which allows the LEDs 143 to be operatively connected directly to the heat sink 141 thus minimizing thermal resistance.

A connector receptacle 145 is operatively connected to the circuit board 142 by solder methods known in the art. This is shown in FIG. 4A. The connector 144 is inserted into the connector receptacle 145 to interconnect a power supply (not shown) and the circuit board 142, which powers the LEDs 143.

The power supply and the circuit board are provided to supply appropriate drive current requirements known in the art. The heat sink 141 is matched with the drive current and the LEDs 143 to maintain operational junction temperature requirements of the LEDs 143. Preferably, the LEDs 143 are spaced approximately 1.5 to 2.0 per linear foot along the length of the heat sink 141. An example of a suitable LED is LUXEON Emitter, Part Number LXHL-DWO1, manufactured by Lumileds Lighting, LLC of San Jose, Calif. Preferably, only a single row of LEDs 143 is used. The LEDs 143 may alternate between white, which is approximately 600° to 630° K CCT, and warmer white, which is approximately 500° to 550° K CCT. The use of alternating white LEDs and warmer white LEDs results in a blended color temperature of approximately 530° to 570° K CCT for the left lighting assembly 140. The LEDs 143 may vary in minimum strength from 39.8 lumens to 50 lumens with a preferred minimum total luminous flux of approximately 450 lumens.

The top cap 146 is secured to the top end of the heat sink 141 with fasteners (not shown), and the top cap 146 may be secured to the left vertical support 103 with fasteners 155 as shown in FIG. 4A. A bottom cap 147 is secured to the bottom end of the heat sink 141 with fasteners (not shown), and the bottom cap 147 may be secured to the left vertical support 103 with fasteners 155 as shown in FIG. 4.

The heat sink 141 includes grooves 141a extending longitudinally proximate each side of the heat sink 141. A reflector 149 corresponds with each of the LEDs 143. The reflectors 149 include a rectangular plate-like base 149a with protruberances 149b extending outward proximate each corner. The protruberances 149b friction-fit into the grooves 141a to operatively connect the reflectors 149 to the heat sink 141 proximate each of the LEDs 143 to direct the light emitted from each of the LEDs 143 in a desired direction. It is recognized that the reflectors 149 may be operatively connected to the heat sink 141 by other suitable means such as with fasteners or an adhesive.

The reflectors 149 also include an aperture 156 in the base 149a through which the corresponding LED 143 extends and partitions operatively connected to the base 149a to direct the light emitted from the LED 143 as shown in FIGS. 4A, 4B, and 4C. Similar to reflector 129, approximately 0.15 to 0.35 inch to the right side of the LED 143 along a center line (not shown) of the LED 143 perpendicular to the longitudinal axis of the reflector 149, an inner top partition 150a extends upward at an angle of approximately 48 to 52° from proximate the right side toward the left side of the LED 143 and an inner bottom partition 151a extends downward at an angle of approximately 48 to 52° from proximate the right side toward the left side of the LED 143. From the juncture of the inner top partition 150a and the inner bottom partition 151a, an outer top partition 150b extends upward at an angle of approximately 48 to 52° from the center line and an outer bottom partition 151b extends downward at an angle of approximately 48 to 52° from the center line.

A top partition 150 extends upward from proximate the outer top partition 150b toward the left side of the LED 143 and a bottom partition 151 extends downward from proximate the outer bottom partition 151b toward the left side of the LED 143. Preferably, the top partition 150 and the bottom partition 151 are concave walls with a radiused profile having a radius of approximately 2.38 to 2.88 inches with an arc length of approximately 2.10 to 2.35 inches. The radii may be either constant or non-constant within the preferred radius range. The top partition 150, the outer top partition 150b, and the inner bottom partition 151a may be contiguous; and the inner top partition 150a, the outer bottom partition 151b, and the bottom partition 151 may be contiguous. Preferably, the inner top partition 150a and the outer bottom partition 151b are in a line and the inner bottom partition 151a and the outer top partition 150b are in a line with the junctures of these partitions overlapping proximate the center line and the right side of the LED 143.

The partitions 150, 150a, 150b, 151, 151a, and 151b are walls extending generally perpendicularly relative to the base 149a forming an opening 153 through which the light is emitted. Preferably, the partitions 150, 150b, 151, and 151b are operatively connected to the base 149a and the partitions 150a and 151a are suspended approximately 0.6 to 0.7 inch above the base 149a, which allows some of the light emitted from the LED 143 to be reflected by the partitions 150, 150b, 151, and 151b. The top partition 150 and the bottom partition 151 are approximately 0.7 to 1.0 inch in height, and the inner top partition 150a and the inner bottom partition 151a are approximately 0.9 to 1.1 inch in length and approximately 0.4 to 0.5 inch in height, and the outer top partition 150b and the outer bottom partition 151b are approximately 0.30 to 0.35 inch in length and approximately 0.60 to 0.63 inch in height. The inner partitions 150a and 151a are shorter in length than the top partition 150 and the bottom partition 151.

A front partition 152 interconnects the partitions 150a and 151a just above the top of the LED 143. Preferably, the front partition 152 is angled upward proximate the juncture of the partitions 150a and 151a toward the left side at an angle of approximately 42 to 48° and has a radius of approximately 1.42 to 1.62 proximate each partition 150a and 151a. A top front partition 152a is parallel to the base 149a and interconnects the partitions 150, 150a, and 150b approximately 0.6 to 0.7 inch above the base 149a. A bottom front partition 152b is parallel to the base 149a and interconnects the partitions 151, 151a, and 151b approximately 0.6 to 0.7 inch above the base 149a. The partitions 152a and 152b are preferably connected to the respective partitions proximate a middle portion of partitions 150, 150b, 151, and 151b, which provide support for the partitions 152a and 152b, and the partitions 150, 150b, 151, and 151b are preferably integral even though the portions above the partitions 152a and 152b do not reflect light. The partitions 152, 152a, and 152b block light above the top of the LED 143, and the base 149a blocks light below the LED 143. The partitions 150, 150a, 150b, 151, 151a, 151b, 152, 152a, and 152b along with the base 149a and the flange 141b direct the light to the left (right relative to the refrigeration unit 100) at an angle of approximately 32 to 40° perpendicular to the longitudinal axis of the reflector 149 and to angles of approximately 24 to 30° above and below the perpendicular line. Additionally, partitions 150, 150a, 150b, 151, 151a, 151b, 152, 152a, and 152b along with the base 149a and the flange 141b direct the light from each LED 143 to the inside of the display case 100 (away from the left vertical support 103) at a directed angle of approximately 4 to 12° (where a majority of the light is directed) and an angle through 0 to 57° (where the light has spread outward). The reflectors 149 are preferably made of a metal coated plastic, but any suitable reflective material may be used.

A cover (not shown), preferably made of a plastic such as polycarbonate, may be used to provide protection to the lighting assemblies without affecting the light uniformity and the illuminance values, preferably losing less than 15% transmissibility through the cover.

If the display unit includes only one door, or one opening if a shelving unit is used, only the right lighting assembly 120 and the left lighting assembly 140 may be needed to provide sufficient, relatively uniform lighting across the front of the merchandise. For two or more doors or openings, a middle lighting assembly 160 may be needed between the doors or openings for additional lighting between the right lighting assembly 120 and the left lighting assembly 140. The middle lighting assembly 160 is also described in an orientation referred to as a front view although the front view of the middle lighting assembly 160 is a different orientation than that described for the refrigeration unit 100. as shown in FIGS. 1 and 2.

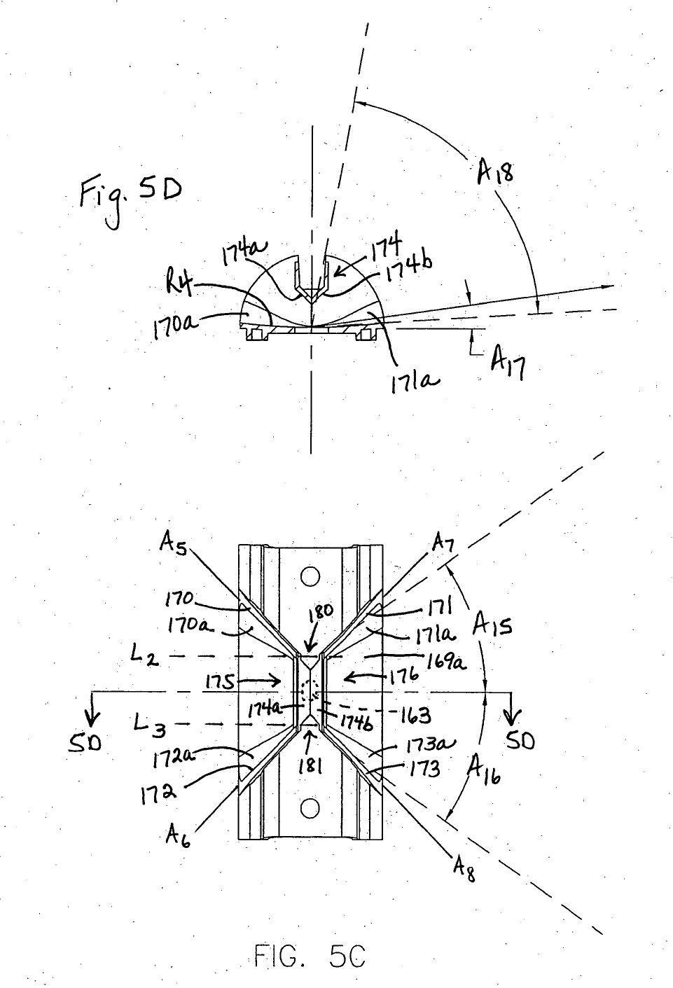

Operatively connected to the interior surface of the middle vertical support 107 within the cavity 113 of the refrigeration unit 100 is the middle lighting assembly 160, which is shown in FIGS. 5 and 7. The middle lighting assembly 160 includes a heat sink 161, which is preferably an elongate piece of aluminum, onto which a flexible printed circuit board 162, a plurality of light emitting diodes (hereinafter “LEDs”) 163, and a plurality of reflectors 169 are operatively connected. The heat sink 161 provides a frame for the middle lighting assembly 160 and also provides a mounting surface for mounting the middle lighting assembly 160 to the middle vertical support 107 of the refrigeration unit 100. The heat sink 161 includes a light reflecting flange 161b extending along its left side and its right side to assist in reflecting light to the left and to the right of the middle lighting assembly 160. The flange 161b may be relatively flat or slightly curved or angled. The circuit board 162 is a thin, flexible circuit, which allows the LEDs 163 to be operatively connected directly to the heat sink 161 thus minimizing thermal resistance.

A connector 164 is operatively connected to a top cap 166 and a connector receptacle 165 is operatively connected to the heat sink 161 by solder methods known in the art. This is shown in FIG. 7A. The connector 164 is inserted into the connector receptacle 165 to interconnect a power supply (not shown) and the circuit board 162, which powers the LEDs 163.

The power supply and the circuit board are provided to supply appropriate drive current requirements known in the art. The heat sink 161 is matched with the drive current and the LEDs 163 to maintain operational junction temperature requirements of the LEDs 163. Preferably, the LEDs 163 are spaced approximately 2.4 to 4.0 per linear foot along the length of the heat sink 161. An example of a suitable LED is LUXEON Emitter, Part Number LXHL-DWO1, manufactured by Lumileds Lighting, LLC of San Jose, Calif. Preferably, only a single row of LEDs 163 is used. The LEDs 163 may alternate between white, which is approximately 600° to 630° K CCT, and warmer white, which is approximately 500° to 550° K CCT. The use of alternating white LEDs and warmer white LEDs results in a blended color temperature of approximately 530° to 570° K CCT for the middle lighting assembly 160. The LEDs 163 may vary in minimum strength from 39.8 lumens to 50 lumens with a preferred minimum total luminous flux of approximately 900 lumens.

The top cap 166 is secured to the top end of the heat sink 161 with fasteners 168, and the top cap 166 may be secured to the middle vertical support 107 with fasteners 178 as shown in FIGS. 5A and 7A. A bottom cap 167 is secured to the bottom end of the heat sink 161 with fasteners 168, and the bottom cap 167 may be secured to the middle vertical support 107 with fasteners 178 as shown in FIGS. 5B and 7B.

The heat sink 161 includes grooves 161 a extending longitudinally proximate each side of the heat sink 161. A reflector 169 corresponds with each of the LEDs 163. The reflectors 169 include a rectangular plate-like base 169a with protruberances 169b extending outward proximate each corner. The protruberances 169b friction-fit into the grooves 161a to operatively connect the reflectors 169 to the heat sink 161 proximate each of the LEDs 163 to direct the light emitted from each of the LEDs 163 in a desired direction. It is recognized that the reflectors 169 may be operatively connected to the heat sink 161 by other suitable means such as with fasteners or an adhesive.

The reflectors 169 also include an aperture 179 in the base 169a through which the corresponding LED 163 extends and partitions operatively connected to the base 169a to direct the light emitted from the LED 163 as shown in FIGS. 5A, 5B, 5C, 5D, 7A, and 7B. Approximately 0.22 to 0.42 inch above the LED 163 is a line L₂ and approximately 0.22 to 0.42 inch below the LED 163 is a line L₃, which are lines perpendicular to the longitudinal axis of the reflector 169. A top left partition 170 extends upward at an angle A₅ of approximately 43 to 47° from the line L₂ proximate above the LED 163 toward the left side of the reflector 169, and a top right partition 171 extends upward at an angle A₇ of approximately 43 to 47° from the line L₂ proximate above the LED 163 toward the right side of the reflector 169, the top left partition 170 and the top right partition 171 being operatively connected and forming a juncture 180 proximate the line L₂ above the LED 163. A bottom left partition 172 extends downward at an angle A₆ of approximately 43 to 47° from the line L₃ proximate below the LED 163 toward the left side of the reflector 169, and a bottom right partition 173 extends downward at an angle A₈ of approximately 43 to 47° from the line L₃ proximate below the LED 163 toward the right side of the reflector 169, the bottom left partition 172 and the bottom right partition 173 being operatively connected and forming a juncture 181 proximate the line L₃ below the LED 163. The top left partition 170 and the top right partition 171 may be contiguous, and the bottom left partition 172 and the bottom right partition 173 may be contiguous.

The top left partition 170, the top right partition 171, the bottom left partition 172, and the bottom right partition 173 are preferably walls extending generally perpendicularly from the base 169a forming an opening 175 to the left and an opening 176 to the right of the reflector through which the light is emitted. Each of the partitions is approximately 1.00 to 1.25 inches in length and approximately 0.7 to 1.0 inch in height. Preferably, the partitions 170, 171, 172, and 173 include fillets 170a, 171a, 172a, and 173a, respectively, interconnecting the respective partition to the base 169a, each fillet with a radius of approximately 0 to 0.375 inch. Further, the base 169a preferably includes a radius R₄ of approximately 6.0 to 6.5 inches. The light emitted from each of the LEDs is directed by each of the reflectors 169 at angles A₁₅ and A₁₆ totaling an angle of approximately 70 to 74° on each side of the LEDs as shown in FIG. 5C. A front partition 174 interconnects the top left partition 170, the top right partition 171, the bottom left partition 172, and the bottom right partition 173 above the LED 163 and blocks the light proximate the front of the reflector 169. The front partition 174 includes a first portion 174a and a second portion 174b operatively connected at approximately a right angle to direct the light out of each of the openings 175 and 176 at an angle A₇ of approximately 4 to 12° through an angle A₁₈ of 0 to 76° as shown in FIG. 5D. Preferably, the front partition 174 is approximately 0.18 to 0.20 inch from the LED 163 and blocks light above the top of the LED 163. The base 169a blocks light below the LED 163. The reflectors 169 are preferably made of a metal coated plastic, but any suitable reflective material may be used.

A cover 177, preferably made of a plastic such as polycarbonate, may be used to provide protection to the lighting assemblies without affecting the light uniformity and the illuminance values, preferably losing less than 15% transmissibility through the cover.

Generally, the reflectors 129, 149, and 169 redirect light emitting from the LEDs to illuminate desired areas and eliminate glare. Therefore, there is less “wasted” light because the light is directed to where it is needed. In addition, the reflectors 129, 149, and 169 block direct light from the LEDs that could be observed by consumers at typical shopping angles, which are slight acute viewing angles relative to the display units. The lighting assemblies 120, 140, and 160 provide sufficient useful lumens to relatively uniformly light the faces of the merchandise contained within the display units proximate the front of the display units. Relatively uniform light is achieved when there is less than 2 to 3 times variation in illuminance values across 80% or more of the merchandise proximate the front of the display units. The reflectors 129, 149, and 169 allow fewer LEDs to be used to achieve sufficient useful lumens to uniformly light the merchandise so that it can be more easily seen by consumers.

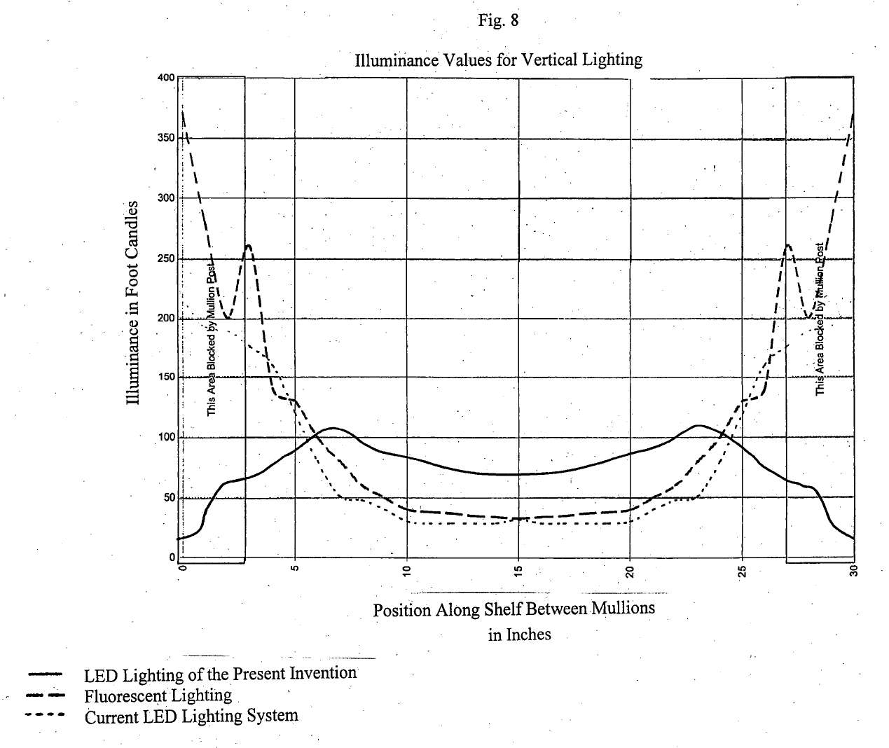

FIG. 8 shows illuminance values measured in foot candles (hereinafter “f.c.”) along the front of the display unit between vertical supports (mullion posts) for vertical lighting using LED lighting of the present invention represented by a solid line, fluorescent lighting represented by long dashed lines, and current LED lighting represented by short dashed lines. The lighting using LED lighting of the present invention varied from approximately 60 f.c. proximate the vertical supports and between the vertical supports to approximately 120 f.c. proximate between the vertical supports and the middle of the display unit, which is a ratio of approximately 2:1. The fluorescent lighting varied from approximately 370 f.c. proximate the vertical supports to less than 40 f.c. proximate between the vertical supports, which is a ratio of more than 9:1. The current LED lighting varied from approximately 200 f.c. proximate the vertical supports to less than 40 f.c. proximate between the vertical supports, which is a ratio of more than 5:1. Thus, the lighting using LED lighting of the present invention is more uniform along the front of the display unit than either the fluorescent lighting or the current LED lighting, which have significantly more light proximate the vertical supports than between the vertical supports.

Because fewer LEDs are needed, less energy is consumed. For right lighting assembly 120 and left lighting assembly 140, approximately 3 Watts of energy is consumed per linear foot under normal operating conditions. For lighting assembly 160, approximately 6 Watts of energy is consumed per linear foot under normal operating conditions. Not only does the present invention consume less energy because fewer LEDs are used, but the LEDs produce very little heat so, in the case of refrigeration units and freezer units, less energy is required to keep the display units at the desired temperature.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A light emitting diode lighting assembly, comprising:
a) a display unit including a front and at least one horizontal support, the front having a left vertical support on a left side of the display unit and a right vertical support on a right side of the display unit, the at least one horizontal support having a front portion proximate the left vertical support and the right vertical support;
b) a first lighting assembly operatively connected to the left vertical support proximate the front portion of the at least one horizontal support, the first lighting assembly including a first plurality of light emitting diodes and a first reflector, the first plurality of light emitting diodes forming a first single row of light emitting diodes extending vertically in a first linear arrangement, each of the first plurality of light emitting diodes being spaced approximately 1.5 to 2.0 per linear foot from adjacent light emitting diodes, the first reflector directing light from the first plurality of light emitting diodes toward the right side of the display unit and the front portion of the at least one horizontal support and illuminating contents of the display unit proximate the front of the display unit; and
c) a second lighting assembly operatively connected to the right vertical support proximate the front portion of the at least one horizontal support, the second lighting assembly including a second plurality of light emitting diodes and a second reflector, the second plurality of light emitting diodes forming a second single row of light emitting diodes extending vertically in a second linear arrangement, each of the second plurality of light emitting diodes being spaced approximately 1.5 to 2.0 per linear foot from adjacent light emitting diodes, the second reflector directing light from the second plurality of light emitting diodes toward the left side of the display unit and the front portion of the at least one horizontal support and illuminating contents of the display unit proximate the front of the display unit.

2. The light emitting diode lighting assembly of claim 1, wherein the display unit is selected from the group consisting of a shelving unit, a refrigeration unit, and a freezer unit.

3. The light emitting diode lighting assembly of claim 1, wherein the first and second light emitting diode assemblies have white light emitting diodes alternating with warmer white light emitting diodes resulting in a blended color temperature of approximately 530° to 570° K CCT for each of the light emitting diode assemblies proximate the front portion of the at least one horizontal support.

4. The light emitting diode lighting assembly of claim 1, wherein the first reflector directs light from the first plurality of light emitting diodes at an angle of approximately 32 to 40° from a line perpendicular to the longitudinal axis of the first reflector and to approximately 24 to 30° above and below the line toward the right side of the display unit and the second reflector directs light from the second plurality of light emitting diodes at an angle of approximately 32 to 40° from a line perpendicular to the longitudinal axis of the first reflector and to approximately 24 to 30° above and below the line toward the left side of the display unit.

5. The light emitting diode lighting assembly of claim 1, wherein the first reflector comprises a plurality of first reflector portions, each first reflector portion corresponding with a light emitting diode, each first reflector portion having a top partition, a bottom partition, and a front partition, the top partition and the bottom partition being concave walls with a radiused profile having a radius of approximately 2.38 to 2.88 inches with an arc length of approximately 2.10 to 2.35 inches, the front partition interconnecting the top partition and the bottom partition above the light emitting diode, the top partition, the bottom partition, and the front partition directing light from the light emitting diode toward the right side of the display unit.

6. The light emitting diode lighting assembly of claim 5, wherein the top partition and the bottom partition angle from approximately 0.15 to 0.35 inch from the light emitting diode and are approximately 0.7 to 1.0 inch in height.

7. The light emitting diode lighting assembly of claim 5, wherein the first reflector further comprises an inner top partition and an inner bottom partition, the inner top partition extending upward from proximate the side of the light emitting diode at an angle of approximately 48 to 52° from the line extending perpendicular to the longitudinal axis of the first lighting assembly proximate the light emitting diode, the inner bottom partition extending downward from proximate the side of the light emitting diode at an angle of approximately 48 to 52° from the line extending perpendicular to the longitudinal axis of the first lighting assembly proximate the light emitting diode, the front partition interconnecting the top partition, the inner top partition, the bottom partition, and the inner bottom partition above the light emitting diode, the top partition, the inner top partition, the bottom partition, the inner bottom partition and the front partition directing light from the light emitting diode toward the right side of the display unit.

8. The light emitting diode lighting assembly of claim 7, wherein approximately 65% of the light is directed by the top partition and the bottom partition and approximately 35% of the light is directed by the inner top partition and the inner bottom partition.

9. The light emitting diode lighting assembly of claim 1, further comprising:
a) a middle vertical support in a middle of the display unit between the left vertical support and the right vertical support; and
b) a third lighting assembly operatively connected to the middle vertical support proximate the front portion of the at least one horizontal support, the third lighting assembly including a third plurality of light emitting diodes and a third reflector, the third plurality of light emitting diodes forming a third single row of light emitting diodes extending vertically in a third linear arrangement, each of the third plurality of light emitting diodes being spaced approximately 2.4 to 4.0 per linear foot from adjacent light emitting diodes, the third reflector directing light from the third plurality of light emitting diodes toward the left side and the right side of the display unit and the front portion of the at least one horizontal support and illuminating contents of the display unit proximate the front of the display unit.

10. The light emitting diode light assembly of claim 9, wherein the first, second, and third light emitting diode assemblies have white light emitting diodes alternating with warmer white light emitting diodes resulting in a blended color temperature of approximately 530° to 570° K CCT for each of the light emitting diode assemblies proximate the front portion of the at least one horizontal support.

11. The light emitting diode lighting assembly of claim 9, wherein the third reflector comprises a plurality of third reflector portions, each third reflector portion corresponding with a light emitting diode, each third reflector portion having a top left partition, a top right partition, a bottom left partition, a bottom right partition, and a front partition, the top left partition extending upward from proximate above the light emitting diode toward an upper left portion at an angle of approximately 43 to 47° from a first line extending perpendicular to a longitudinal axis of the first lighting assembly proximate above the light emitting diode, the top right partition extending upward from proximate above the light emitting diode toward an upper right portion at an angle of approximately 43 to 47° from the first line extending perpendicular to the longitudinal axis of the first lighting assembly proximate above the light emitting diode, the bottom left partition extending downward from proximate below the light emitting diode toward a lower left portion at an angle of approximately 43 to 47° from a second line extending perpendicular to the longitudinal axis of the first lighting assembly proximate below the light emitting diode, the bottom right partition extending downward from proximate below the light emitting diode toward a lower right portion at an angle of approximately 43 to 47° from the second line extending perpendicular to the longitudinal axis of the first lighting assembly proximate below the light emitting diode, the front partition interconnecting the top left partition, the top right partition, the bottom left partition, and the bottom right partition proximate the light emitting diode, each third reflector portion directing light from the light emitting diode toward the left side and the right side of the display unit.

12. The light emitting diode lighting assembly of claim 11, wherein the first line is approximately 0.22 to 0.42 inch above the light emitting diode and the second line is approximately 0.22 to 0.42 inch below the light emitting diode.

13. The light emitting diode lighting assembly of claim 11, wherein the top left partition, the top right partition, the bottom left partition, and the bottom right partition are approximately 1.00 to 1.25 inches in length and approximately 0.7 to 1.0 inch in height.

14. A light emitting diode lighting assembly, comprising:
a) a plurality of light emitting diodes; and
b) a reflector comprising a plurality of reflector portions, each reflector portion corresponding with a light emitting diode, each reflector portion having a top partition, a bottom partition, and a front partition, the top partition and the bottom partition being concave walls with a radiused profile having a radius of approximately 2.38 to 2.88 inches with an arc length of approximately 2.10 to 2.35 inches, the front partition interconnecting the top partition and the bottom partition above the light emitting diode, the top partition, the bottom partition, and the front partition directing light from the light emitting diode toward an opposing side of the light emitting diode.

15. The light emitting diode lighting assembly of claim 14, wherein the top partition and the bottom partition angle from approximately 0.15 to 0.35 inch from the light emitting diode and are approximately 0.7 to 1.0 inch in height.

16. The light emitting diode lighting assembly of claim 14, wherein each of the plurality of light emitting diodes is spaced approximately 1.5 to 2.0 per linear foot from adjacent light emitting diodes.

17. The light emitting diode lighting assembly of claim 14, wherein the plurality of light emitting diodes are white light emitting diodes alternating with warmer white light emitting diodes resulting in a blended color temperature of approximately 530° to 570° K CCT for the plurality of light emitting diodes.

18. The light emitting diode lighting assembly of claim 14, wherein the reflector directs light from each of the plurality of light emitting diodes at an angle of approximately 32 to 40° from a line perpendicular to the longitudinal axis of the reflector and to approximately 24 to 30° above and below the line toward the opposing side of the light emitting diode.

19. The light emitting diode lighting assembly of claim 14, wherein the reflector further comprises an inner top partition and an inner bottom partition, the inner top partition extending upward from proximate the side of the light emitting diode at an angle of approximately 48 to 52° from the line extending perpendicular to the longitudinal axis of the reflector proximate the light emitting diode, the inner bottom partition extending downward from proximate the side of the light emitting diode at an angle of approximately 48 to 52° from the line extending perpendicular to the longitudinal axis of the reflector proximate the light emitting diode, the front partition interconnecting the top partition, the inner top partition, the bottom partition, and the inner bottom partition above the light emitting diode.

20. The light emitting diode lighting assembly of claim 19, wherein approximately 65% of the light is directed by the top partition and the bottom partition and approximately 35% of the light is directed by the inner top partition and the inner bottom partition.

21. The light emitting diode lighting assembly of claim 14, wherein the plurality of light emitting diodes and the reflector achieve uniform lighting having a ratio of no greater than 2 to 1.

22. A light emitting diode lighting assembly, comprising:
a) a plurality of light emitting diodes; and
b) a reflector comprising a plurality of reflector portions, each reflector portion corresponding with a light emitting diode, each reflector portion having a top left partition, a top right partition, a bottom left partition, a bottom right partition, and a front partition, the top left partition extending upward from proximate above the light emitting diode toward an upper left portion at an angle of approximately 43 to 47° from a first line extending perpendicular to a longitudinal axis of the reflector proximate above the light emitting diode, the top right partition extending upward from proximate above the light emitting diode toward an upper right portion at an angle of approximately 43 to 47° from the first line extending perpendicular to the longitudinal axis of the reflector proximate above the light emitting diode, the bottom left partition extending downward from proximate below the light emitting diode toward a lower left portion at an angle of approximately 43 to 47° from a second line extending perpendicular to the longitudinal axis of the reflector proximate below the light emitting diode, the bottom right partition extending downward from proximate below the light emitting diode toward a lower right portion at an angle of approximately 43 to 47° from the second line extending perpendicular to the longitudinal axis of the reflector proximate below the light emitting diode, the front partition interconnecting the top left partition, the top right partition, the bottom left partition, and the bottom right partition proximate the light emitting diode, each reflector portion directing light from the light emitting diode toward a left side and a right side of the reflector.

23. The light emitting diode lighting assembly of claim 22, wherein each of the plurality of light emitting diodes is spaced approximately 2.4 to 4.0 per linear foot from adjacent light emitting diodes.

24. The light emitting diode lighting assembly of claim 22, wherein the plurality of light emitting diodes are white light emitting diodes alternating with warmer white light emitting diodes resulting in a blended color temperature of approximately 530° to 570° K CCT for the plurality of light emitting diodes.

25. The light emitting diode lighting assembly of claim 22, wherein the first line is approximately 0.22 to 0.42 inch above the light emitting diode and the second line is approximately 0.22 to 0.42 inch below the light emitting diode.

26. The light emitting diode lighting assembly of claim 22, wherein the top left partition, the top right partition, the bottom left partition, and the bottom right partition are approximately 1.00 to 1.25 inches in length and approximately 0.7 to 1.0 inch in height.

27. The light emitting diode lighting assembly of claim 22, wherein the plurality of light emitting diodes and the reflector achieve uniform lighting having less than 3 times variation in illuminance values.
